(19) United States
(12) Patent Application Publication
(10) Pub. No.: US 2016/0316344 A1
(43) Pub. Date: Oct. 27, 2016

(54) MOBILE ELECTRONIC DEVICE, CONTROL METHOD, AND STORAGE MEDIUM

(71) Applicant: KYOCERA CORPORATION, Kyoto-shi, Kyoto (JP)

(72) Inventor: Masato HARIKAE, Machida-shi, Tokyo (JP)

(21) Appl. No.: 15/103,878

(22) PCT Filed: Dec. 19, 2014
(86) PCT No.: PCT/JP2014/083777

§ 371 Date: Jun. 13, 2016

(30) Foreign Application Priority Data
Dec. 20, 2013 (JP) 2013-264413

(51) Int. Cl. H04W 4/04; G01C 5/06

(52) U.S. Cl. CPC H04W 4/04; G01C 5/06

(57) ABSTRACT

A mobile electronic device includes a communicator, a sensor, a determinator, and an annunciator. The communicator receives first atmospheric pressure information from other device. The sensor measures second atmospheric pressure information. The determinator determines a positional relationship between the other device and the own device based on the first atmospheric pressure information and the second atmospheric pressure information. The annunciator performs notification according to the positional relationship determined by the determinator. The determinator determines whether, in a building, the other device is located on a same floor as a floor where the own device is located, or on an upper floor than the floor where the own device is located, or on a lower floor than the floor where the own device is located, as the positional relationship, based on the compared relationship between the first atmospheric pressure information and the second atmospheric pressure information.

### RELATED APPLICATIONS

The present application is a National Phase entry of International Application No. PCT/JP2014/083777, filed Dec. 19, 2014.

### FIELD

The present application relates to a mobile electronic device, a control method, and a storage medium.

### BACKGROUND

Some of communicable mobile electronic devices such as mobile phones and smartphones have a function of transmitting its own positional information measured to a predetermined destination in response to a predetermined action (see Patent Literature 1).

### CITATION LIST

### Patent Literature

Patent Literature 1: Japanese Laid-open Patent Publication No. 2012-21851

### SUMMARY

Incidentally, as explained above, mobile electronic devices such as conventional mobile phones only transmit the positional information in response to the predetermined action.

In one aspect, A mobile electronic device comprises a communicator configured to receive first atmospheric pressure information from other device, a sensor, also called an atmospheric pressure measurement sensor hereinafter, configured to measure second atmospheric pressure information, a determinator of a controller, that is the controller, configured to determine a positional relationship between the other device and the own device based on comparison between the first atmospheric pressure information and the second atmospheric pressure information, and a annunciator of the controller, that is the controller, configured to perform notification according to the positional relationship determined by the determinator.

In one aspect, a control method for controlling a mobile electronic device including a communicator and an atmospheric pressure measurement sensor, the control method comprises a step of receiving first atmospheric pressure information from other device by the communicator, a step of measuring second atmospheric pressure information by the atmospheric pressure measurement sensor, a step of determining a positional relationship between the other device and the own device based on comparison between the first atmospheric pressure information and the second atmospheric pressure information, and a step of performing notification according to the determined positional relationship.

In one aspect, a non-transitory storage medium has a control program for causing a mobile electronic device, including a communicator and an atmospheric pressure measurement sensor, to execute a step of receiving first atmospheric pressure information from other device by the communicator, a step of measuring second atmospheric pressure information by the atmospheric pressure measurement sensor, a step of determining a positional relationship between the other device and the own device based on comparison between the first atmospheric pressure information and the second atmospheric pressure information, and a step of performing notification according to the determined positional relationship.

### BRIEF DESCRIPTION OF DRAWINGS

FIG. 1 is a block diagram illustrating a functional configuration of a mobile phone according to an example in a plurality of embodiments.

FIG. 2 is a diagram illustrating an example of a positional relationship between one user of one mobile phone and the other user of the other mobile phone in a same building.

FIG. 3 is a diagram illustrating an example of a positional relationship between one user of one mobile phone and the other user of the other mobile phone in the same building.

FIG. 4 is a flowchart illustrating an example of a procedure executed by a mobile phone according to a first embodiment.

FIG. 5 is a flowchart illustrating an example of a procedure executed by a mobile phone according to a second embodiment.

FIG. 6 is a diagram illustrating an example of a moving form of the user carrying the mobile phone.

FIG. 7 is a diagram illustrating an example of the moving form of the user carrying the mobile phone.

FIG. 8 is a diagram illustrating an example of the moving form of the user carrying the mobile phone.

### DETAILED DESCRIPTION

A plurality of embodiments for implementing a mobile electronic device, a control method, and a control program included in a storage medium according to the present application will be explained in detail below with reference to the accompanying drawings. A mobile phone will be explained below as an example of a plurality of mobile electronic devices. In the following embodiments, an example in which a user of a mobile phone 100 and a user of a mobile phone 200 are visiting a same building will be explained.

### First Embodiment

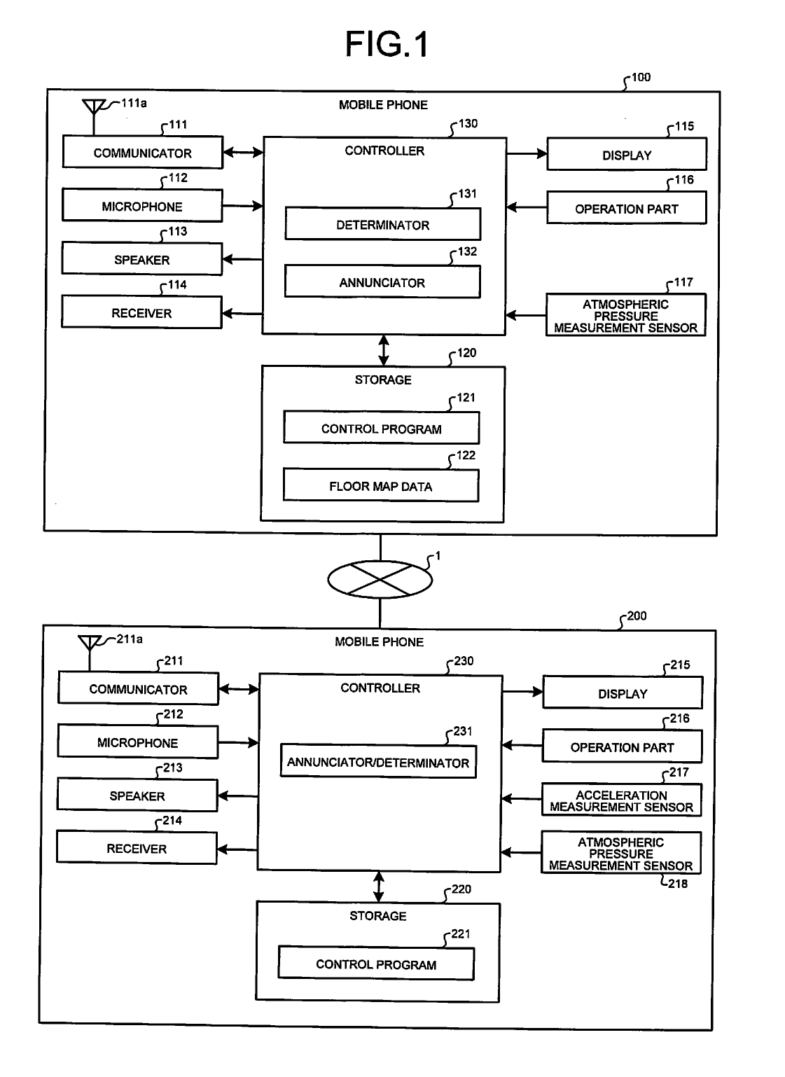

A functional configuration of a mobile phone according to the embodiment will be explained below with reference to FIG. 1. FIG. 1 is a block diagram illustrating the functional configuration of a mobile phone according to an example in the embodiments. As illustrated in FIG. 1, the mobile phone 100 and the mobile phone 200 are connected to each other in a mutually communicable state via a communication network 1. The mobile phone 100 is an example of the own device and the mobile phone 200 is an example of other device. Hereinafter, the mobile phone 100 is described as “the own device” accordingly. In the following explanation, same reference signs may be assigned to like components. Moreover, the overlapping explanation may be omitted.

As illustrated in FIG. 1, the mobile phone 100 includes a communicator 111, a microphone 112, a speaker 113, a receiver 114, a display 115, an operation part 116, an atmospheric pressure measurement sensor 117, a storage 120, and a controller 130.

The communicator 111 performs communication via the communication network 1. The communicator 111 has an antenna 111a. The communicator 111 performs, for example, telephone communication and information communication with the mobile phone 200 via a base station. The communicator 111 in this example establishes a wireless signal line with the base station via a channel allocated by the base station. The wireless signal line includes a CDMA (Code Division Multiple Access) system and the like. In the first embodiment, the communicator 111 receives atmospheric pressure information transmitted from the mobile phone 200 and sends it to the controller 130. In the first embodiment, the atmospheric pressure information received by the communicator 111 from the mobile phone 200 is treated as first atmospheric pressure information.

The communicator 111 may be configured to receive a radio signal of a predetermined frequency band from a GPS satellite in order to, for example, perform position measurement processing. The position measurement processing is executed in, for example, the controller 130. For example, the communicator 111 performs demodulation processing of the radio signal received from the GPS satellite and transmits the processed signal to the controller 130. The mobile phone 100 may provide a receiver, separately from the communicator 111, for receiving a radio signal of a predetermined frequency band from a GPS satellite.

The microphone 112 inputs, for example, voice upon voice call. The speaker 113 is provided, for example, inside a housing of the mobile phone 100. The speaker 113 outputs a ringtone for voice call and a sound upon transmission and reception of mail, and the like. The receiver 114 outputs, for example, voice upon voice call.

The display 115 displays various types of information such as texts, graphics, and images according to a signal input from the controller 130. In the first embodiment, the display 115 displays a message for notifying the user of information on a positional relationship between the mobile phone 200 and the mobile phone 100 (the own device), a floor map of the building which the user of the mobile phone 100 is visiting, and the like. The display 115 is configured to include, for example, a display panel. The display panel includes a liquid crystal display, an organic electro-luminescence display, and the like.

The operation part 116 receives an operation of the user. The operation part 116 sends a signal according to the received operation to the controller 130. The operation part 116 is configured to include, for example, one or more devices for receiving the operation of the user. The device includes, for example, a key, a button, and a touch screen.

The atmospheric pressure measurement sensor 117 measures atmospheric pressure at a current position of the mobile phone 100 (the own device). The atmospheric pressure measurement sensor 117 sends the measured atmospheric pressure information to the controller 130. In the first embodiment, the atmospheric pressure information measured by the atmospheric pressure measurement sensor 117 is treated as second atmospheric pressure information.

The storage 120 stores programs and data. The storage 120 is used also as a working area that temporarily stores a processing result of the controller 130. The storage 120 may be configured to include any non-transitory storage medium such as a semiconductor storage medium and a magnetic storage medium. The storage 120 may be configured to include a plurality of types of storage medium. The storage 120 may be configured to include a combination of a portable storage medium such as a memory card, an optical disk, or a magneto-optical disk with a reading device of the storage medium. The storage 120 may be configured to include a storage device used as a temporary storage area such as RAM (Random Access Memory).

In the embodiment, the storage 120 stores, for example, a control program 121 and floor map data 122 as illustrated in FIG. 1.

The control program 121 provides a function for determining a positional relationship between the mobile phone 200 (other device) and the mobile phone 100 (own device) in the building based on the comparison between the first atmospheric pressure information received by the communicator 111 from the mobile phone 200 (other device) and the second atmospheric pressure information measured by the atmospheric pressure measurement sensor 117. The control program 121 provides a function for performing notification according to the determination result of the positional relationship.

The floor map data 122 corresponds to data of a floor map of the building which the user of the mobile phone 100 is visiting.

The controller 130 is a processor. Examples of the processor are configured to include, but are not limited to, a CPU (Central Processing Unit), SoC (System-on-a-chip), an MCU (Micro Control Unit), an FPGA (Field-Programmable Gate Array), and a coprocessor. The controller 130 integrally controls the operations of the mobile phone 100 to implement various functions.

Specifically, the controller 130 executes commands included in the program stored in the storage 120 while referring to the data stored in the storage 120 as necessary. The controller 130 then controls function modules according to the data and the commands and thereby implements the various functions. Examples of the function module include, but are not limited to, the communicator 111, the speaker 113, the receiver 114, and the display 115. The controller 130 can change the control according to the detection result of detectors. Examples of the detector include, but are not limited to, the operation part 116 and the atmospheric pressure measurement sensor 117.

The controller 130 executes the control program 121 to implement the functions provided by the control program 121 as processing by a determinator 131 and as processing by an annunciator 132. The determinator 131 is an example of determinators, and the annunciator 132 is an example of annunciators.

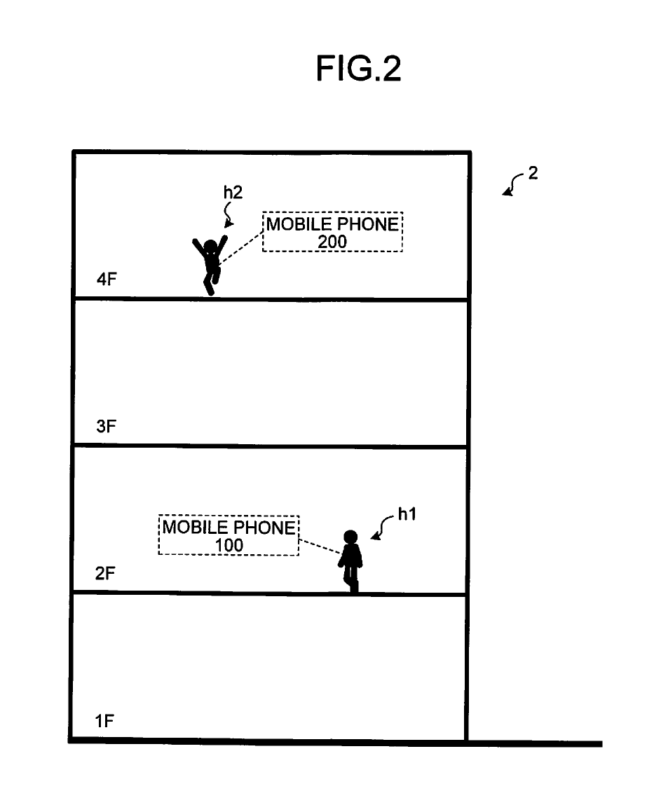

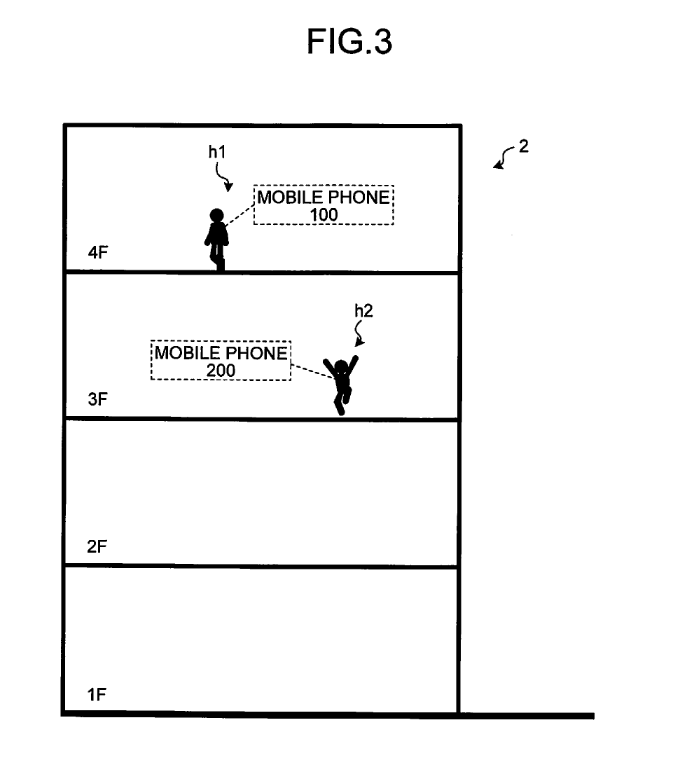

The determinator 131 determines a positional relationship between the mobile phone 200 (other device) and the mobile phone 100 (the own device) in the building based on the result of comparison between the first atmospheric pressure information received by the communicator 111 from the mobile phone 200 (other device) and the second atmospheric pressure information measured by the atmospheric pressure measurement sensor 117. The processing performed by the determinator 131 will be explained below with reference to FIG. 2 and FIG. 3. FIG. 2 and FIG. 3 are diagrams illustrating examples of the positional relationship between one user of one mobile phone and the other user of the other mobile phone in the same building.

The determinator 131 compares the atmospheric pressure information received from the mobile phone 200 and the atmospheric pressure information measured by the atmospheric pressure measurement sensor 117. The determinator 131 determines whether there is a difference in atmospheric pressure between atmospheric pressure value measured in the mobile phone 200 and an atmospheric pressure value measured by the own device. When there is a difference in atmospheric pressure as a result of determination, the determinator 131 determines the positional relationship between the mobile phone 200 and the own device based on the result of comparison between the atmospheric pressure information received from the mobile phone 200 and the atmospheric pressure information measured by the atmospheric pressure measurement sensor 117. For example, when the atmospheric pressure measured in the mobile phone 200 is lower than the atmospheric pressure measured by the atmospheric pressure measurement sensor 117, the determinator 131 determines that a user h2 carrying the mobile phone 200 is located on an upper floor (e.g., fourth floor) than a floor where a user h1 carrying the own device is located, in a 4-story building 2 as illustrated in FIG. 2. On the other hand, when the atmospheric pressure measured in the mobile phone 200 is higher than the atmospheric pressure measured by the atmospheric pressure measurement sensor 117, the determinator 131 determines, as illustrated in FIG. 3, that the user h2 carrying the mobile phone 200 is located on a lower floor (e.g., third floor) than a floor where the user h1 carrying the own device is located.

When there is no atmospheric pressure difference as a result of determining whether there is a difference in atmospheric pressure between the atmospheric pressure measured in the mobile phone 200 and the atmospheric pressure value measured by the own device, the determinator 131 determines that the mobile phone 200 is located on the same floor as the floor where the own device is located. The determinator 131 may not have to determine the positional relationship as to whether the user h2 is located on an upper floor than the floor where the user h1 is located or on a lower floor than the floor where the user h1 is located. The determinator 131 may determine that there is a difference in atmospheric pressure based on the fact that the difference between the two atmospheric pressures is higher than a predetermined range. The determinator 131 may determine that there is no difference in atmospheric pressure based on the fact that the difference between the two atmospheric pressures is lower than the predetermined range.

The annunciator 132 executes notification according to the positional relationship determined by the determinator 131. Specifically, when the determinator 131 determines that the mobile phone 200 is located on an upper floor than the floor where the own device is located, the annunciator 132 displays a message that the mobile phone 200 is on the upper floor than the floor where the own device is located on the display 115. Meanwhile, when the determinator 131 determines that the mobile phone 200 is located on a lower floor than the floor where the own device is located, the annunciator 132 displays a message that the mobile phone 200 is located on the lower floor than the floor where the own device is located on the display 115.

As illustrated in FIG. 1, the mobile phone 200 includes a communicator 211, a microphone 212, a speaker 213, a receiver 214, a display 215, an operation part 216, an acceleration measurement sensor 217, an atmospheric pressure measurement sensor 218, a storage 220, and a controller 230.

The communicator 211 performs communication via the communication network 1. The communicator 211 has an antenna 211a. The communicator 211 performs, for example, telephone communication and information communication with the mobile phone 100 via the base station. For the communicator 211 in this example, in the embodiment, the communicator 211 establishes a wireless signal line with the base station via a channel allocated by the base station. The wireless signal line includes a CDMA (Code Division Multiple Access) system and the like. In the first embodiment, the communicator 211 receives atmospheric pressure information transmitted from the mobile phone 100 and sends it to the controller 230. In the first embodiment, the communicator 211 transmits the atmospheric pressure information in relation to the atmospheric pressure measured by the atmospheric pressure measurement sensor 218, explained later, to the mobile phone 100.

The communicator 211 may be configured to receive a radio signal of a predetermined frequency band from a GPS satellite in order to, for example, perform position measurement processing. The position measurement processing is executed in, for example, the controller 230. The communicator 211 performs demodulation processing of the radio signal received from the GPS satellite and sends the processed signal to the controller 230. The mobile phone 200 may provide a receiver, separately from the communicator 211, for receiving a radio signal of a predetermined frequency band from a GPS satellite.

The microphone 212 inputs, for example, a voice signal upon voice call. The speaker 213 is provided, for example, inside a housing of the mobile phone 200. The speaker 213 outputs a ringtone for voice call and a sound upon transmission and reception of mail, and the like. The receiver 214 outputs, for example, a voice signal upon voice call.

The display 215 displays various types of information such as texts, graphics, and images according to a signal input from the controller 230. The display 215 is configured to include, for example, a display panel. The display panel includes a liquid crystal display, an organic electro-luminescence display, and the like.

The operation part 216 receives an operation of the user. The operation part 216 sends the signal corresponding to the received operation to the controller 230. The operation part 216 is configured to include, for example, one or more devices for receiving the operation of the user. The device includes, for example, a key, a button, and a touch screen.

The acceleration measurement sensor 217 measures acceleration acting on the mobile phone 200. The acceleration measurement sensor 217 sends the information of the measured acceleration to the controller 230.

The atmospheric pressure measurement sensor 218 measures atmospheric pressure at the current position of the mobile phone 200. The atmospheric pressure measurement sensor 218 sends the information of the measured atmospheric pressure to the controller 230.

The storage 220 stores programs and data. The storage 220 is used also as a working area that temporarily stores a processing result of the controller 230. The storage 220 may be configured to include any non-transitory storage medium such as a semiconductor storage medium and a magnetic storage medium. The storage 220 may be configured to include a plurality of types of storage medium. The storage 220 may be configured to include a combination of a portable storage medium such as a memory card, an optical disk, or a magneto-optical disk with a reading device of the storage medium. The storage 220 may be configured to include a storage device used as a temporary storage area such as RAM (Random Access Memory).

In the embodiment, the storage 220 stores, for example, a control program 221 as illustrated in FIG. 1.

The control program 221 provides a function for detecting occurrence of a predetermined event based on the atmospheric pressure information measured by the atmospheric pressure measurement sensor 218. The control program 221 provides a function for detecting, for example, a change in the atmospheric pressure measured by the atmospheric pressure measurement sensor 218 as an event. The change in the atmospheric pressure may be detected based on comparison with a predetermined threshold or may be detected based on a time series variation of the atmospheric pressure measured by the atmospheric pressure measurement sensor 218. The control program 221 provides a function for transmitting the atmospheric pressure information measured by the atmospheric pressure measurement sensor 218 to the mobile phone 100 when detecting the occurrence of the predetermined event. For example, when detecting the occurrence of the predetermined event, the control program 221 provides a function for transmitting atmospheric pressure information in relation to the atmospheric pressure measured by the atmospheric pressure measurement sensor 218 at the time of the occurrence of the predetermined event to the mobile phone 100.

The controller 230 is a processor. Examples of the processor are configured to include, but are not limited to, a CPU (Central Processing Unit), SoC (System-on-a-chip), an MCU (Micro Control Unit), an FPGA (Field-Programmable Gate Array), and a coprocessor. The controller 230 integrally controls the operations of the mobile phone 200 to implement various functions.

Specifically, the controller 230 executes commands included in the program stored in the storage 220 while referring to the data stored in the storage 220 as necessary. The controller 230 then controls function modules according to the data and the commands and thereby implements the various functions. Examples of the function module include, but are not limited to, the communicator 211, the speaker 213, the receiver 214, and the display 215. The controller 230 can change the control according to the detection result of detectors. Examples of the detector include, but are not limited to, the operation part 216, the acceleration measurement sensor 217, and the atmospheric pressure measurement sensor 218.

The controller 230 executes the control program 221 to implement the function provided by the control program 221 as processing by a annunciator/determinator 231.

The annunciator/determinator 231 implements the processing of detecting the occurrence of a predetermined event based on the atmospheric pressure information measured by the atmospheric pressure measurement sensor 218. The annunciator/determinator 231 detects, for example, the change in the atmospheric pressure measured by the atmospheric pressure measurement sensor 218 as an event. The change in the atmospheric pressure may be detected based on comparison with the predetermined threshold or may be detected based on the time series variation of the atmospheric pressure measured by the atmospheric pressure measurement sensor 218.

When detecting the occurrence of the predetermined event, the annunciator/determinator 231 implements the processing of transmitting the atmospheric pressure information measured by the atmospheric pressure measurement sensor 218 to the mobile phone 100. The annunciator/determinator 231 transmits the atmospheric pressure information in relation to the atmospheric pressure measured by the atmospheric pressure measurement sensor 218 at the time of occurrence of the predetermined event to the mobile phone 100.

The functional configurations of the mobile phone 100 and the mobile phone 200 illustrated in FIG. 1 are only examples among a plurality of configurations, and may therefore be appropriately modified within a range that does not impair the gist of the mobile electronic device, the control method, and the control program according to the present application.

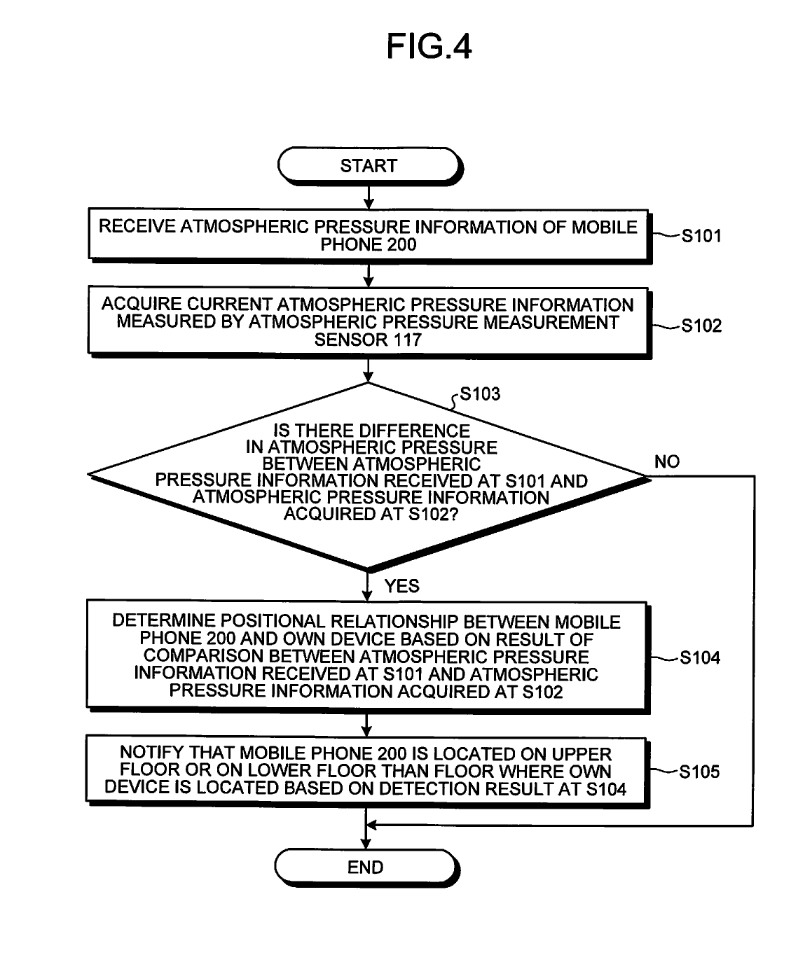

An example of a procedure executed by the mobile phone 100 according to the first embodiment will be explained with reference to FIG. 4. FIG. 4 is a flowchart illustrating an example of the procedure executed by the mobile phone 100 according to the first embodiment. The procedure illustrated in FIG. 4 is implemented by the controller 130 executing the control program 121 or the like stored in the storage 120.

As illustrated in FIG. 4, when receiving the atmospheric pressure information of the mobile phone 200 (Step S101), the controller 130 acquires current atmospheric pressure information measured by the atmospheric pressure measurement sensor 117 (Step S102).

Subsequently, the controller 130 determines whether there is a difference in atmospheric pressure between the atmospheric pressure information received at Step S101 and the atmospheric pressure information acquired at Step S102 (Step S103).

When there is a difference in atmospheric pressure between the atmospheric pressure information received at Step S101 and the atmospheric pressure information acquired at Step S102 as a result of determination at Step S103 (Yes at Step S103), the controller 130 determines a positional relationship between the mobile phone 200 and the own device based on the result of comparison between the atmospheric pressure information received at Step S101 and the atmospheric pressure information acquired at Step S102 (Step S104).

The controller 130 notifies that the mobile phone 200 is located on the upper floor or on the lower floor than the floor where the own device is located based on the determination result at Step S104 (Step S105), and ends the processing illustrated in FIG. 4.

At Step S103, when there is no difference in atmospheric pressure between the atmospheric pressure information received at Step S101 and the atmospheric pressure information acquired at Step S102 as a result of determination at Step S103 (No at Step S103), the controller 130 ends the processing illustrated in FIG. 4.

In the first embodiment, the mobile phone 100 determines the positional relationship between the mobile phone 200 and the own device based on the result of comparison between the atmospheric pressure information received from the mobile phone 200 and the atmospheric pressure information measured by the atmospheric pressure measurement sensor 117. The mobile phone 100 performs notification according to the determined positional relationship. For example, when the atmospheric pressure measured in the mobile phone 200 is lower than the atmospheric pressure measured in the own device, the mobile phone 100 determines that the user h2 carrying the mobile phone 200 is located on the upper floor than the floor where the user h1 carrying the own device is located (see FIG. 2). The mobile phone 100 notifies that the user h2 carrying the mobile phone 200 is located on the upper floor than the floor where the user h1 carrying the own device is located. Meanwhile, when the atmospheric pressure measured in the mobile phone 200 is higher than the atmospheric pressure measured in the own device, the mobile phone 100 determines that the user h2 carrying the mobile phone 200 is located on the lower floor than the floor where the user h1 carrying the own device (see FIG. 3) is located. The mobile phone 100 notifies that the user h2 carrying the mobile phone 200 is located on the lower floor than the floor where the user h1 carrying the own device is located. For this reason, according to the first embodiment, the mobile phone 100 enables the user to more easily understand the positional relationship between the mobile phone 200 as the other device and the own device.

In the first embodiment, the mobile phone 100 may transmit a transmission request of the atmospheric pressure information to the mobile phone 200 and receive the atmospheric pressure information from the mobile phone 200. The mobile phone 200 may transmit the atmospheric pressure information to the mobile phone 100 in response to the transmission request of the atmospheric pressure information from the mobile phone 100. The mobile phone 200 may transmit the atmospheric pressure information to the mobile phone 100 in response to the operation of the user h2 carrying the mobile phone 200.

In the first embodiment, the mobile phone 100 may calculate which floor the mobile phone 200 is located on based on the comparison of the atmospheric pressure difference, between the atmospheric pressure value measured in the mobile phone 200 and the atmospheric pressure value measured in the own device, with the floor map data 122 to notify the calculated floor. For example, the mobile phone 100 causes the user h1 to enter the floor that he/she is located on. Subsequently, the mobile phone 100 converts the difference in atmospheric pressure between the atmospheric pressure value measured in the mobile phone 200 and the atmospheric pressure value measured in the own device into a height difference. The mobile phone 100 checks the converted height difference against the floor map data 122 and calculates which floor the mobile phone 200 is located on.

### Second Embodiment

In the first embodiment, it may be configured that after the mobile phone 100 notifies that the mobile phone 200 as the other device is located on the floor different from the floor where the own device is located, the mobile phone 100 notifies that the mobile phone 200 is located on the same floor as the floor where the own device is located according to the change in the positional relationship between the mobile phone 200 and the own device.

The mobile phone 100 has the same functional configuration as the configuration of the first embodiment; however, at least some points explained herein below will be different.

The control program 121 provides a function for notifying that the mobile phone 200 is located on the same floor as the floor where the own device is located according to the change in the positional relationship between the mobile phone 200 and the own device.

After the determinator 131 notifies that the mobile phone 200 is located on the floor different from the floor where the own device is located using the annunciator 132, the determinator 131 acquires again the current atmospheric pressure information measured by the atmospheric pressure measurement sensor 117. The determinator 131 compares the current atmospheric pressure information measured by the atmospheric pressure measurement sensor 117 and the atmospheric pressure information received from the mobile phone 200. The mobile phone 100 compares these pieces of atmospheric pressure information and determines whether there is a difference in atmospheric pressure between the atmospheric pressure value measured in the mobile phone 200 and the atmospheric pressure value measured in the own device.

When there is a difference in atmospheric pressure, the determinator 131 acquires again the current atmospheric pressure information measured by the atmospheric pressure measurement sensor 117. When there is a difference in atmospheric pressure, the determinator 131 continues to compare the acquired current atmospheric pressure information and the atmospheric pressure information received from the mobile phone 200 and determine whether there is a difference in atmospheric pressure between the atmospheric pressure value measured in the mobile phone 200 and the atmospheric pressure value measured in the own device. Meanwhile, when there is no difference in atmospheric pressure, the determinator 131 determines that the mobile phone 200 is on the same floor as the floor where the own device is located. When there is no difference in atmospheric pressure, the determinator 131 commands the annunciator 132 to notify a message that the mobile phone 200 is located on the same floor as the floor where the own device is located.

The annunciator 132 displays the message that the mobile phone 200 is located on the same floor as the floor where the own device is located on the display 115 according to the command from the determinator 131.

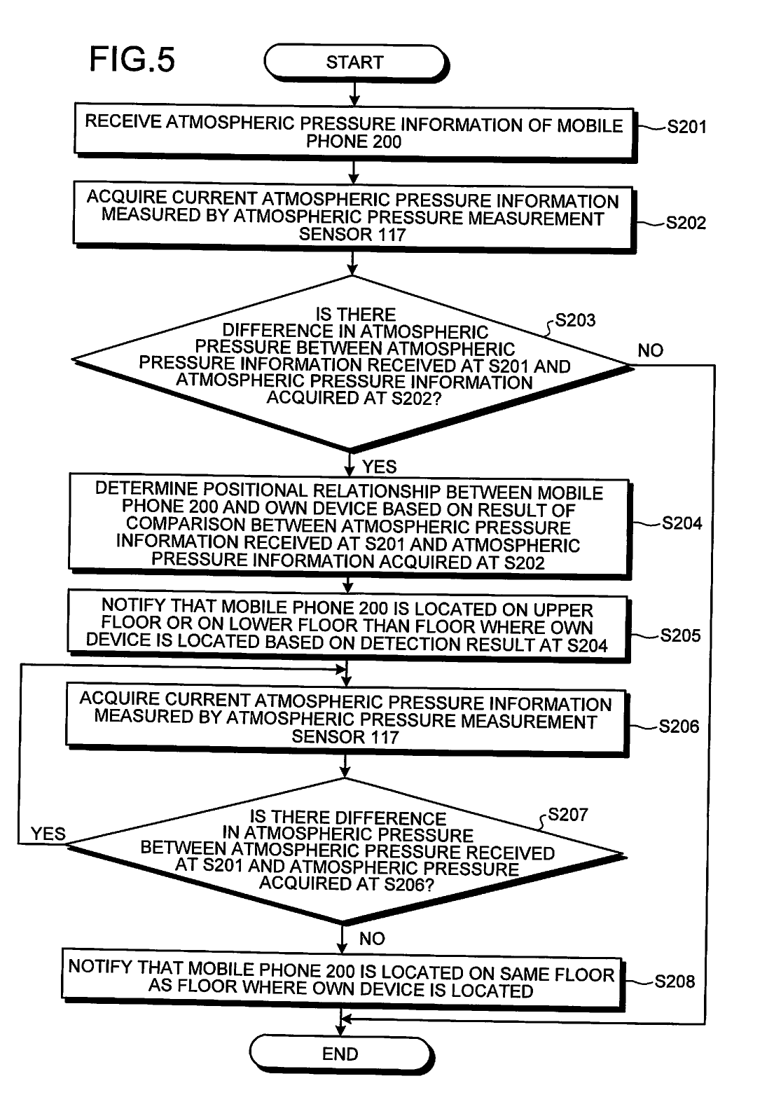

An example of a procedure executed by the mobile phone 100 according to the second embodiment will be explained with reference to FIG. 5. FIG. 5 is a flowchart illustrating an example of the procedure executed by the mobile phone 100 according to the second embodiment. The procedure illustrated in FIG. 5 is implemented by the controller 130 executing the control program 121 or the like stored in the storage 120. For the procedure illustrated in FIG. 5, processing at step S206 to Step S208 is different from the procedure of the mobile phone 100 according to the first embodiment illustrated in FIG. 4.

As illustrated in FIG. 5, when receiving the atmospheric pressure information of the mobile phone 200 (Step S201), the controller 130 acquires the current atmospheric pressure information measured by the atmospheric pressure measurement sensor 117 (Step S202).

Subsequently, the controller 130 determines whether there is a difference in atmospheric pressure between the atmospheric pressure information received at Step S201 and the atmospheric pressure information acquired at Step S202 (Step S203).

When there is a difference in atmospheric pressure between the atmospheric pressure information received at Step S201 and the atmospheric pressure information acquired at Step S202 as a result of determination (Yes at Step S203), the determinator 131 determines the positional relationship between the mobile phone 200 and the own device based on the result of comparison between the atmospheric pressure information received at Step S201 and the atmospheric pressure information acquired at Step S202 (Step S204).

The controller 130 notifies that the mobile phone 200 is located on the upper floor or on the lower floor than the floor where the own device is located based on the determination result at Step S204 (Step S205).

Subsequently, the controller 130 acquires the current atmospheric pressure information measured by the atmospheric pressure measurement sensor 117 (Step S206), and determines whether there is a difference in atmospheric pressure between the atmospheric pressure information received at Step S201 and the atmospheric pressure information acquired at Step S206 (Step S207).

When there is a difference in atmospheric pressure between the atmospheric pressure information received at Step S201 and the atmospheric pressure information acquired at Step S206 as a result of determination (Yes at Step S207), the controller 130 returns to Step S206. The controller 130 acquires the current atmospheric pressure information measured by the atmospheric pressure measurement sensor 117 and performs the determination at Step S207.

Meanwhile, when there is no difference in atmospheric pressure between the atmospheric pressure information received at Step S201 and the atmospheric pressure information acquired at Step S206 as a result of determination (No at Step S207), the controller 130 notifies that the mobile phone 200 is located on the same floor as the floor where the own device (Step S208) is located, and ends the processing illustrated in FIG. 5.

At Step S203, when there is no difference in atmospheric pressure between the atmospheric pressure information received at Step S201 and the atmospheric pressure information acquired at Step S202 as a result of determination (No at Step S203), the controller 130 ends the processing illustrated in FIG. 5.

In the second embodiment, after the mobile phone 100 notifies that the mobile phone 200 as the other device is located on the different floor from the floor where the own device is located, the mobile phone 100 notifies that the mobile phone 200 is located on the same floor as the floor where the own device is located according to the change in the positional relationship between the mobile phone 200 and the own device. Therefore, the mobile phone 100 can notify the user, for example, of arriving at the floor where the user of the mobile phone 200 is supposed to be located when the user of the mobile phone 100 arrives at the floor. The mobile phone 100 enables the user to more easily understand the positional relationship between the mobile phone 200 as the other device and the own device.

### Other Embodiments

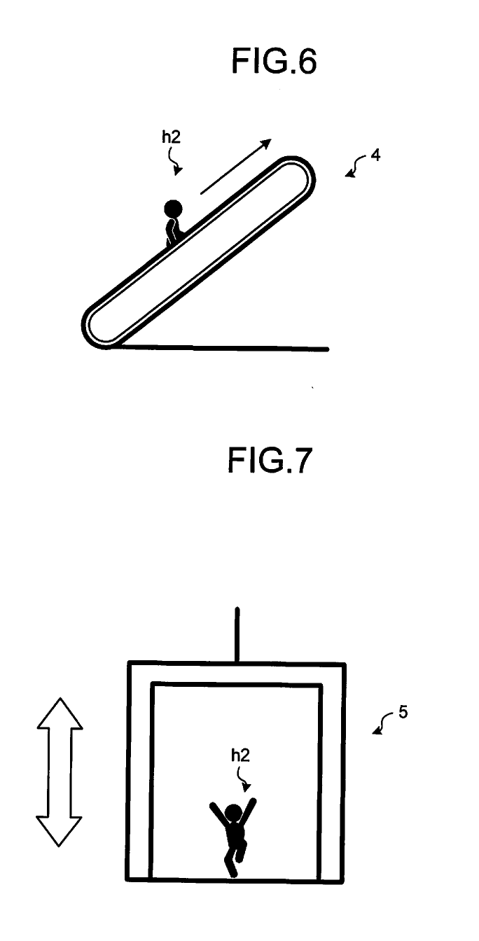

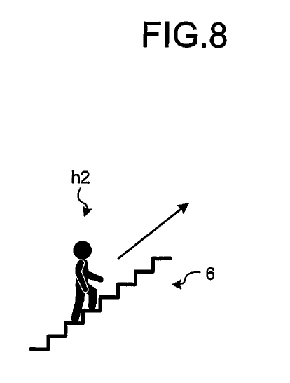

The mobile phone 200 may determine a moving form of the user h2 carrying the mobile phone 200 based on the acceleration information measured by the acceleration measurement sensor 217 and the atmospheric pressure information measured by the atmospheric pressure measurement sensor 218. FIG. 6 to FIG. 8 are diagrams illustrating examples of the moving form of the user carrying the mobile phone 200.

The controller 230 determines to which of movement by an escalator 4, movement by an elevator 5, and movement by stairs 6 the moving form of the user h2 carrying the mobile phone 200 corresponds, based on the acceleration information and the atmospheric pressure information. The storage 220 previously stores the acceleration information detected on moving by means of the escalator 4, the elevator 5, and the stairs 6, as reference information. When there is a time series variation in the atmospheric pressure information measured by the atmospheric pressure measurement sensor 218, the controller 230 collates the acceleration information stored as the reference information in the storage 220 with the acceleration information measured by the acceleration measurement sensor 217, and determines to which of the movement by the escalator 4, the movement by the elevator 5, and the movement by the stairs 6 the moving form corresponds. The controller 230 transmits the atmospheric pressure information along with the information of the moving form, that is, the movement by the escalator 4, the movement by the elevator 5, or the movement by the stairs to the mobile phone 100.

On the other hand, the mobile phone 100 performs notification based on the atmospheric pressure information received from the mobile phone 200 and the information of the moving form. For example, the mobile phone 100 notifies that the user of the mobile phone 200 has moved to the upstairs by the escalator 4.

In the embodiments, for example, the control program 121 illustrated in FIG. 1 may be divided into a plurality of program modules respectively corresponding to the determinator 131 and the annunciator 132 of the controller 130. Alternatively, the control program 121 illustrated in FIG. 1 may be combined with the other program.

In the embodiments, the mobile phone 100 may determine whether the user h1 of the mobile phone 100 and the user h2 of the mobile phone 200 are in the same building. The mobile phone 100 performs the determination by comparing the signal obtained by processing the radio signal from the GPS satellite received by the mobile phone 200 with the radio signal from the GPS satellite received by the mobile phone 100 or by comparing the signal obtained by processing the radio signal from the GPS satellite received by the mobile phone 200 with the signal obtained by processing the radio signal from the GPS satellite received by the mobile phone 100.

In the embodiments, the mobile phone has been explained as an example of the mobile electronic device according to the appended claims; however, the electronic device according to the appended claims is not limited to the mobile phone. The mobile electronic device according to the appended claims may be any electronic device other than the mobile phone if the device can perform communication and can measure atmospheric pressure.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A mobile electronic device comprising:
a communicator configured to receive first atmospheric pressure information from other device;
a sensor configured to measure second atmospheric pressure information;
a controller configured to determine a positional relationship between the other device and the own device based on comparison between the first atmospheric pressure information and the second atmospheric pressure information; and
configured to perform notification according to the positional relationship determined.

2. The mobile electronic device according to claim 1, wherein
the controller is configured to determine whether, in a building, the other device is located on a same floor as a floor where the own device is located, or on an upper floor than the floor where the own device is located, or on a lower floor than the floor where the own device is located, as the positional relationship, and
the controller performs the notification when the controller determines that the other device is located on the upper floor or on the lower floor than the floor where the own device is located.

3. The mobile electronic device according to claim 2, wherein
the controller performs the notification when the determination determines that the other device is located on the same floor as the floor where the own device is located after the controller determines that the other device is located on the upper floor or on the lower floor than the floor where the own device is located.

4. A control method for controlling a mobile electronic device including a communicator and a sensor, the control method comprising:
a step of receiving first atmospheric pressure information from other device by the communicator;
a step of measuring second atmospheric pressure information by the sensor;
a step of determining a positional relationship between the other device and the own device based on comparison between the first atmospheric pressure information and the second atmospheric pressure information; and
a step of performing notification according to the determined positional relationship.

5. A non-transitory storage medium having a control program for causing a mobile electronic device, including a communicator and a sensor, to execute:
a step of receiving first atmospheric pressure information from other device by the communicator;
a step of measuring second atmospheric pressure information by the sensor;
a step of determining a positional relationship between the other device and the own device based on comparison between the first atmospheric pressure information and the second atmospheric pressure information; and
a step of performing notification according to the determined positional relationship.
